(19) United States
(12) Patent Application Publication
(10) Pub. No.: US 2024/0239421 A1
(43) Pub. Date: Jul. 18, 2024

(54) FAIRING ASSEMBLY FOR A COMMERCIAL VEHICLE

(71) Applicant: DAIMLER TRUCK AG, Leinfelden-Echterdingen (DE)

(72) Inventors: Jackson SLOCUM, Portland, OR (US); Chihao MAC, Milwaukie, OR (US)

(21) Appl. No.: 18/563,986

(22) PCT Filed: Mar. 23, 2022
(86) PCT No.: PCT/EP2022/057589

§ 371 Date: Nov. 24, 2023

(30) Foreign Application Priority Data
May 25, 2021 (GB) 2107425.7

(51) Int. Cl. B62D 35/00

(52) U.S. Cl. CPC B62D 35/001

(57) ABSTRACT

A fairing assembly for a commercial vehicle is disclosed that includes a fairing and a mounting device for mounting the fairing to a frame. The mounting device includes a four bar linkage having a first arm which is pivotably connected with the fairing, the first arm being configured to be pivotably connected with the frame. The linkage also includes a second arm which is pivotably connected with the fairing, the second arm being configured to be pivotably connected with the frame such that the mounting device allows the fairing to move between a covering position for laterally covering at least a major portion of a wheel of the commercial vehicle and an uncovering position for uncovering the wheel.

### FIELD OF THE INVENTION

The invention relates to a fairing assembly for a commercial vehicle.

### BACKGROUND INFORMATION

US 2018/0111646 A1 shows a fairing assembly for a commercial vehicle, the fairing assembly comprising a fairing and a mounting system for mounting the fairing on a frame of the commercial vehicle. Moreover, US 2018/0297645 A1 shows a fairing assembly for an axle of a commercial vehicle, the fairing assembly comprising a forward fairing configured to be disposed at least partially in front of a drive wheel of the axle with respect to a longitudinal direction of the commercial vehicle. Moreover, US 2014/0238761 A1 shows a truck comprising a frame with an operator cab thereon.

### SUMMARY OF THE INVENTION

It is an object of the present invention to provide a fairing assembly for a commercial vehicle such that a particularly good usability of the fairing assembly may be realized.

This object is solved by a fairing assembly having the features of patent claim 1. Advantageous embodiments with expedient developments of the invention are indicated in the other patent claims.

The invention relates to a fairing assembly for a commercial vehicle such as, for example, a truck. The fairing assembly comprises at least one fairing. The fairing assembly further comprises a mounting device which is also referred to as a mounting system. The mounting device is configured to mount the fairing to a frame of the commercial vehicle. In other words, the fairing may be connected at least indirectly with the frame by the mounting device. The mounting device comprises at least one four bar linkage including a first arm which is, at least indirectly, pivotably connected with the fairing. Thus, the first arm and the fairing may be pivoted in relation to each other whilst the first arm and the fairing are connected with each other. Furthermore, the first arm is configured to be, at least indirectly, pivotably connected with the frame.

The four bar linkage further includes a second arm which is, at least indirectly, pivotably connected with the fairing. Thus, the second arm and the fairing may be pivoted in relation to each other whilst the fairing and the second arm are connected with each other. Moreover, the second arm is configured to be, at least indirectly, pivotably connected with the frame such that the fairing may be pivotably connected with the frame by the four bar linkage (i.e. by the first and second arms). Hence, the mounting device allows the fairing to move, in particular pivot, between a covering position for laterally covering at least a major portion of a wheel of the vehicle and an uncovering position for uncovering the wheel. This means, for example, in a completely assembled state of the vehicle, at least a major portion of the wheel is covered by the fairing in a transverse direction of the vehicle towards an outside of the vehicle when the fairing is in its covering position. In the uncovering position, at least said major portion of the wheel is not covered by the fairing in the transverse direction of the vehicle towards the outside. The four bar linkage allows the fairing to pivot in a particularly easy and space saving way. Thus, a particularly advantageous usability of the fairing assembly may be realized.

Further advantages, features, and details of the invention derive from the following description of preferred embodiments as well as from the drawings. The features and feature combinations previously mentioned in the description as well as the features and feature combinations mentioned in the following description of the figures and/or shown in the figures alone can be employed not only in the respectively indicated combination but also in any other combination or taken alone without leaving the scope of the invention.

### BRIEF DESCRIPTION OF THE DRAWINGS

The novel features and characteristic of the disclosure are set forth in the appended claims. The accompanying drawings, which are incorporated in and constitute a part of this disclosure, illustrate exemplary embodiments and together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described below, by way of example only, and with reference to the accompanying figures.

The drawings show in:

FIG. 1 is part of a schematic perspective view of a commercial vehicle comprising a fairing assembly according to a first embodiment.

FIG. 2 is a schematic and sectional front view of the commercial vehicle comprising the fairing assembly according to the first embodiment.

FIG. 3 is part of a schematic, perspective and sectional view of the commercial vehicle comprising a second embodiment of the fairing assembly.

FIG. 4 is part of a schematic, sectional and perspective view of the commercial vehicle comprising a third embodiment of the fairing assembly.

In the figures the same elements or elements having the same function are indicated by the same reference signs.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawing and will be described in detail below. It should be understood, however, that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion so that a setup, device or method that comprises a list of components or steps does not include only those components or steps but may include other components or steps not expressly listed or inherent to such setup or device or method. In other words, one or more elements in a system or apparatus preceded by “comprises” or “comprise” does not or do not, without more constraints, preclude the existence of other elements or additional elements in the system or method.

In the following detailed description of the embodiment of the disclosure, reference is made to the accompanying drawing that forms part hereof, and in which is shown by way of illustration a specific embodiment in which the disclosure may be practiced. This embodiment is described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

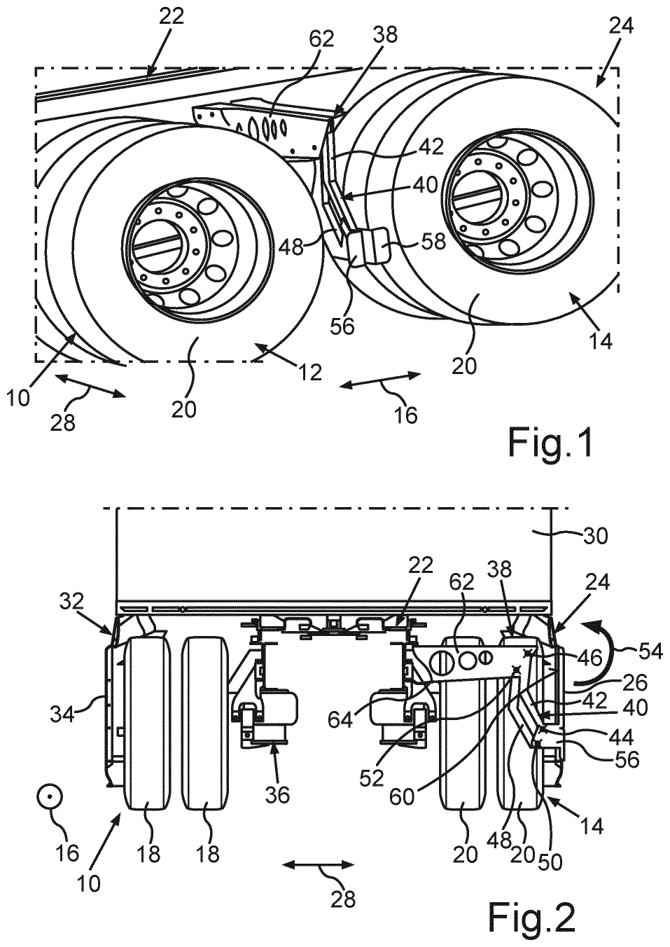

FIGS. 1 and 2 show a commercial vehicle 10 which may be configured as a truck. The commercial vehicle 10 has at least two axles 12 and 14 which are arranged one after another in a longitudinal direction of the commercial vehicle 10, wherein the longitudinal direction of the commercial vehicle 10 is illustrated by a double arrow 16. The respective axle 12, 14 comprises respective wheels 18 and 20. Furthermore, the commercial vehicle comprises a frame 22 which may be configured as a ladder frame. The axles 12 and 14 are mounted to the frame 22, in particular in such a way that the wheels 18 and 20 may rotate in relation to the frame 22. At least one of the axles 12 and 14 is a drive axle. For example, both axles 12 and 14 are drive axles. The commercial vehicle 10 comprises at least one motor which is not shown in the figures. By the motor, the wheels 18 and 20 of the respective drive axle may be driven thereby driving the commercial vehicle 10.

The commercial vehicle 10 further comprises a fairing assembly 24 which is at least indirectly mounted to the frame 22. The fairing assembly 24 comprises at least one fairing 26 (shown in FIGS. 2-4) which is shown transparent in FIG. 1. FIGS. 1 and 2 show a first embodiment of the fairing assembly 24. As will be explained in greater detail below, the fairing 26 may be moved, in particular pivoted, between a covering position shown in FIGS. 1 and 2 and at least one uncovering position. In the covering position, at least a respective major portion of the respective wheel 20 is covered by the fairing 26 in a transverse direction of the commercial vehicle 10 towards an outside of the commercial vehicle 10, wherein, in FIGS. 1 and 2, the transverse direction of the commercial vehicle 10 is illustrated by a double arrow 28.

In FIG. 2, part of a body 30 of the commercial vehicle 10 is shown, the body 30 being mounted to the frame 22. Moreover, as shown in FIG. 2, the commercial vehicle 10 comprises a second fairing assembly 32 comprising a second fairing 34 which may also be moved between a covering position shown in FIG. 2 and at least one uncovering position. In the covering position of the second fairing 34, at least a respective major portion of the respective wheel 18 is covered by the fairing 34 in the transverse direction of the commercial vehicle 10 towards the outside. In the uncovering position of the fairing 26, said respective major portion of the respective wheel 18 is not covered by the fairing 26. Moreover, in the uncovering position of the fairing 34, said respective major portion of the respective wheel 18 is not covered by the fairing 34 in the transverse direction of the commercial vehicle 10 towards the outside. Since, for example, the wheels 18 and 20 are configured as drive wheels, the fairings 26 and 34 are drive wheel fairings. Since, in the covering positions, at least the major portions of the wheels 18 and 20 are covered by the fairings 26 and 34, the fairings 26 and 34 are full drive wheel fairings. Furthermore, for example, the commercial vehicle 10 comprises a suspension system 36 by which the axles 12 and 14 are mounted to the frame 22. Thus, for example, the wheels 18 and 20 are spring supported to the frame 22 by the suspension system 36.

Full drive wheel fairings are large aerodynamic fairings which are added to a body such as a cab of a commercial vehicle such as the commercial vehicle 10. The full drive wheel fairings such as the fairings 26 and 34 are panels configured to cover the wheels 18 and 20 at least predominantly, and continue chassis fairings, for example, all the way passed mud flaps to a rear of the commercial vehicle 10. In the covering positions, the fairings 26 and 34 cover up large portions of the commercial vehicle 10, which may need to be inspected and accessed from time to time. Furthermore, the fairings 26 and 34 should be able to be moved in relation to the wheels 18 and 20 to allow for chain install and adjustments. Therefore, it is desirable to design the fairing assembly 24, 32 in such a way that the respective fairing 26, 34 may be moved particularly easily. As shown and explained by the example of the fairing assembly 24, the fairing assembly 24 comprises a mounting device 38 for mounting the faring 26 to the frame 22. Thus, with respect to the commercial vehicle 10, the faring 26 is mounted to the frame 22 by the mounting device 38. As will be explained in greater detail below, the fairing 26 is movably, in particular pivotably, held on the frame 22 by the mounting device 38.

In order to realize a particularly good usability of the fairing assembly 24, the mounting device 38 comprises at least one four bar linkage 40. The four bar linkage 40 comprises a first arm 42 which is also referred to as an upper arm. The first arm 42 is at least indirectly pivotably connected with the fairing 26. Furthermore, the first arm 42 is at least indirectly pivotably connected with the frame 22. Thus, the first arm 42 may be pivoted in relation to the fairing 26 about a first rotation axis 44 whilst the first arm 42 is connected with the fairing 26. Moreover, the first arm 42 may be pivoted in relation to the frame 22 about a second rotation axis 46 whilst the first arm 42 is connected with or held on the frame 22. As shown in FIG. 2, the rotation axes are spaced away from each other. The four bar linkage 40 further comprises a second arm 48 which is also referred to as a lower arm. The second arm 48 is at least indirectly pivotably connected with the fairing 26, in particular in such a way that the second arm 48 is pivotable in relation to the fairing 26 about a third rotation axis 50. Furthermore, the second arm 48 is at least indirectly pivotably connected with a frame 22 in such a way that the second arm 48 may be pivoted in relation to the frame 22 about a fourth rotation axis 52. As shown in FIG. 2, the rotation axes 50 and 52 are spaced away from each other, wherein the rotation axis 50 is spaced away from the rotation axes 44 and 46, and wherein the rotation axis 52 is spaced away from the rotation axes 44 and 46. Moreover, the rotation axes 44, 46, 50 and 52 extend parallel to each other.

Since the fairing 26 is movably, in particular pivotably, held on the frame 22 by the four bar linkage 40, the mounting device 38 is configured to hold the fairing 26 in the covering position. Moreover, the mounting device 38 allows the fairing 26 to move, in particular pivot, between the covering position for laterally covering at least the respective major portion of the respective wheel 20 and the uncovering position for uncovering the respective wheel 20. In FIG. 2, an arrow 54 illustrates a movement of the fairing 26 from the covering position to the uncovering position. When moved from the covering position to the uncovering position, the four bar linkage 40 guides the fairing 26 in such a way that the fairing 26, on its way from the covering position to the uncovering position, moves a bit outwards in the transverse direction of the commercial vehicle 10 and upwards in a vertical direction of the commercial vehicle 10. The outward movement of the fairing 26 in the transverse direction of the commercial vehicle 10 is kept particularly low by the four bar linkage 40 such that the fairing 26 may be moved, in particular pivoted, between the covering position and the uncovering position in a particularly space saving way.

Conventionally, designs or solutions are used in order to pivot drive wheel fairings out of the way in order to complete tasks such as installing chains, or for inspection of break lines, tire wear, lug nuts, fixing flats, pressurizing tires etc. However, conventional designs do not make it easy for a user to operate due to a large amount of effort needed in order to perform a pivoting of the fairings. In contrast to conventional solutions, the fairing assembly 24 allows to particularly easily move, in particular pivot, the fairing 26 between the covering position and the uncovering position. The fairing 26 may be even moved between the covering position and the uncovering position while the commercial vehicle 10 is parked in close proximity of another vehicle in the transverse direction of the commercial vehicle 10, for example at a truck stop. Moreover, the fairing assembly 24 may provide improved aerodynamic performance of the commercial vehicle 10 since the wheels 18 and 20 are covered at least predominantly in the covering positions. The four bar linkage 40 is a mechanism allowing the fairing 26 to be used in order to experience an aerodynamic benefit without hindering other necessary tasks which are to be completed through access to the drive wheels. The fairing assembly 24, in particular the four bar linkage 40, also allows for clearance in order to install chains whilst maintaining an extra aerodynamic benefit. Preferably, the rotation axes 44, 46, 50 and 52 are revolute joints or are defined or realized by revolute joints, said revolute joints allowing the fairing 26 to be moved or pivoted upwards, thereby moving the fairing 26 from the covering position to the uncovering position, and to be moved or pivoted downwards thereby moving the fairing 26 from the uncovering position to the covering position.

In the first embodiment, the mounting device 38 comprises two first-base elements 56 and 58 which are also referred to or configured as plates. The base elements 56 and 58 are mounted or attached to the fairing 26. Particularly, the base elements 56 and 58 are attached or mounted to an interior side 60 of the fairing 26. The base elements 56 and 58 are spaced away from each other in the longitudinal direction of the commercial vehicle 10 such that, for example, respective portions, in particular end portions, of the arms 42 and 48 are arranged between the base elements 56 and 58. For example, said portions, in particular end portions, of the arms 42 and 48 are pivotably connected with the base elements 56 and 58 such that the arms 42 and 48 are pivotably connected with the fairing 26 via the base elements 56 and 58.

Furthermore, the mounting device 38 comprises at least one second base element 62 which may be configured as a bracket. The base element 62 is at least indirectly attached or mounted to the frame 22. For example, the base element 62 is mounted or attached to the frame 24 by a bracket 64. For example, the base element 62 is mounted to the suspension system 36 via the bracket 64 such that, for example, the arms 42 and 48 are pivotably held on the frame 22 via the base element 26 and the bracket 64.

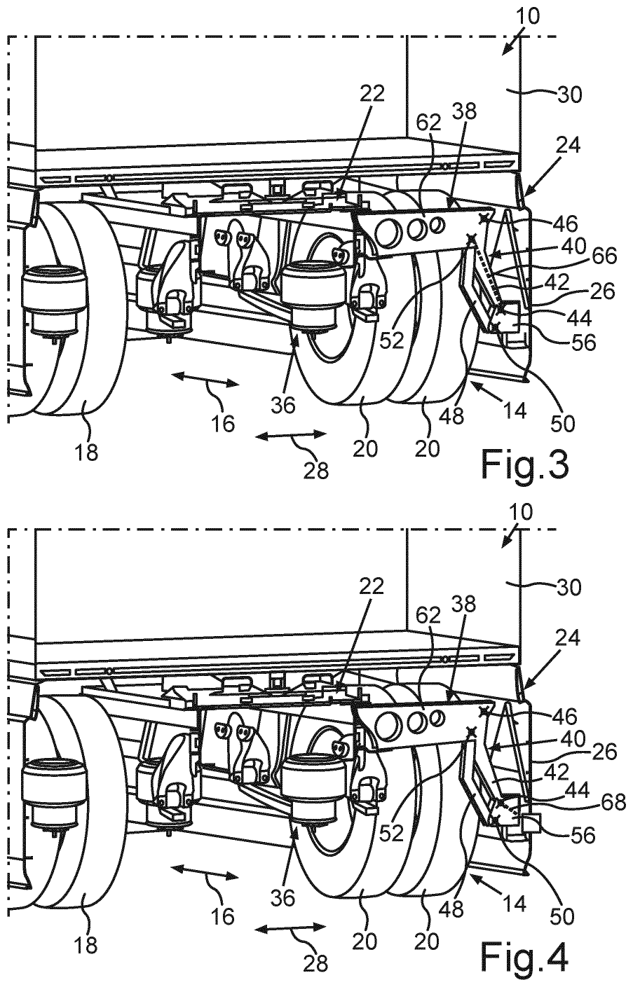

FIG. 3 shows a second embodiment of the fairing assembly 24. In the second embodiment, the fairing assembly 24 comprises at least one gas strut 66 which is also referred to as a gas assisted spring. The gas strut 66 is configured to hold the fairing 26 in the covering position. Alternatively or additionally, the gas strut 66 is configured to hold the fairing 26 in the uncovering position. Alternatively or additionally, the gas strut 66 is configured to move the fairing 26 in the direction of the uncovering position. Alternatively or additionally, the gas strut 66 is configured to support a movement of the fairing to or in the direction of the uncovering position. Thus, the fairing 26 may be moved, in particular pivoted, between the covering position and the uncovering position in a particularly easy way. For example, the gas strut 66 is mounted at least two points of the four bar linkage 40. A first one of said points may be a point at or of the lower arm 48. For example, a second one of said points may be a point of or at the upper arm 42. Thus, for example, the gas strut 66 may be pivotably connected with both arms 42 and 48. Thus, the gas strut 66 allows the fairing 26 to be pivoted with these. Alternatively, the gas strut 66, which is also referred to as a spring element, may be mounted via an attachment to at least one of said plates of the lower arm 48.

FIG. 4 shows a third embodiment in which a spring element 68 may be attached to at least or exactly one of the plates (base elements 56 and 58) of the lower arm 48. In other words, in the third embodiment shown in FIG. 4, a spring element 68 may be attached to at least or exactly one of the plates (first base elements 56 and 58) of the second, lower arm 48. For example, the spring element 68 is a mechanical spring. Moreover, preferably, the spring element 68 maybe configured as a gas strut such as the gas strut 66.

In a fourth embodiment not shown in the figures, two spring elements may be mounted, one at each of the rotation axes 46 and 52. In other words, a first spring element may be mounted at a point through which the rotation axis 46 extends. In other words, a first spring element may be mounted in such a way that the first spring element effects a first torque extending around the rotation axis 46 in such a way that the first torque may effect or at least support a movement of the fairing 26 to the uncovering position or in the direction of the uncovering position. Preferably, the first spring element is supported on the base element 62 and the first, upper arm 42.

For example, a second spring element may be mounted at a point through which the rotation axis 52 extends. In other words, for example, a second spring element may be mounted in such a way that the second spring element effects a second torque around the rotation axis 52 in such a way that the second torque may effect or at least support the movement of the fairing 26 to the uncovering position or in the direction of the uncovering position. Preferably, the second spring element is supported on the base element 62 and the second, lower arm 48. Preferably, the first spring element and/or the second spring element may be configured as a mechanical spring such as, for example, a torsion spring or leg spring. Thus, the fairing 26 may be moved in a particularly easy way.

In an embodiment, the fairing assembly 24 may comprise a locking mechanism to lock the fairing 26, and thus the four bar linkage 40, in place. For example, the fairing 26 may be locked via a latch with the four bar linkage 40. The fairing 26 may comprise a lever, or comprise a key slot, in which a user may interact with in order to operate the latch to lock the fairing 26 in place.

### LIST OF REFERENCE SIGNS

10 commercial vehicle
12 axle
14 axle
16 double arrow
18 wheel
20 wheel
22 frame
24 fairing assembly
26 fairing
28 double arrow
30 body
32 fairing assembly
34 fairing
36 suspension system
38 mounting structure
40 four bar linkage
42 first arm
44 rotation axis
46 rotation axis
48 second arm
50 rotation axis
52 rotation axis
54 arrow
56 first base element
58 first base element
60 interior side
62 second base element
64 bracket
66 gas strut
68 spring element

1. A fairing assembly for a commercial vehicle, the fairing assembly comprising:
at least one fairing; and
a mounting device for mounting the fairing to a frame of the commercial vehicle, the mounting device comprising at least one four bar linkage including:
a first arm which is, at least indirectly, pivotably connected with the fairing, the first arm being configured to be, at least indirectly, pivotably connected with the frame; and
a second arm which is, at least indirectly, pivotably connected with the fairing, the second arm being configured to be, at least indirectly, pivotably connected with the frame such that the mounting device allows the fairing to move between a covering position for laterally covering at least a major portion of a wheel of the commercial vehicle and an uncovering position for uncovering the wheel.

2. The fairing assembly according to claim 1, wherein the mounting device comprises at least one first base element attached to the fairing, and wherein the first and second arms are pivotably connected with the first base element.

3. The fairing assembly according to claim 2, wherein the mounting device comprises a second base element configured to be attached to frame at least indirectly, and wherein the first and second arms are pivotably connected with the second base element.

4. The fairing assembly according to claim 1, wherein the mounting device comprises at least one gas strut configured to:
hold the fairing in the covering position; and/or
hold the fairing in the uncovering position; and/or
move the fairing in the direction of the uncovering position; and/or
support a movement of the fairing to the uncovering position.

5. The fairing assembly according claim 4, wherein the at least one gas strut is pivotably connected with both the first and second arms.

6. The fairing assembly according to claim 2, wherein the mounting device comprises at least one gas strut configured to:
hold the fairing in the covering position; and/or
hold the fairing in the uncovering position; and/or
move the fairing in the direction of the uncovering position; and/or
support a movement of the fairing to the uncovering position, and
wherein the at least one gas strut is pivotably connected with the at least one first base element.

7. The fairing assembly according to claim 3, wherein the mounting device comprises at least one gas strut configured to:
hold the fairing in the covering position; and/or
hold the fairing in the uncovering position; and/or
move the fairing in the direction of the uncovering position; and/or
support a movement of the fairing to the uncovering position, and
wherein the at least one gas strut is pivotably connected with the at least one first base element.
